(19) United States
(12) Patent Application Publication
(10) Pub. No.: US 2025/0277988 A1
(43) Pub. Date: Sep. 4, 2025

(54) STEREOSCOPIC IMAGE DISPLAY DEVICE

(71) Applicant: LG Display Co., Ltd., Seoul (KR)

(72) Inventors: Gyu Suk JUNG, Paju-si (KR); Dong Yeon KIM, Paju-si (KR); Hee Cheol KIM, Paju-si (KR); Ju Hoon JANG, Paju-si (KR); Myung Soo PARK, Paju-si (KR); Gyo Hyun KOO, Paju-si (KR)

(21) Appl. No.: 18/920,545

(22) Filed: Oct. 18, 2024

(30) Foreign Application Priority Data
Feb. 29, 2024 (KR) 10-2024-0029968

(51) Int. Cl. G02B 30/27

(52) U.S. Cl. CPC G02B 30/27

(57) ABSTRACT

A stereoscopic image display device includes a display panel that displays an image, and a plurality of lenses disposed on the display panel, wherein the display panel includes a plurality of unit pixels including a first pixel, a second pixel, and a third pixel that are disposed in a first direction, the plurality of unit pixels are disposed in a second direction intersecting the first direction, pixels included in each of the plurality of unit pixels are pixels disposed in the second direction to emit light of different colors, and the plurality of lenses extend in a third direction intersecting the first direction and the second direction. According to the techniques of the present disclosure, it is possible to prevent vertical image distortion and a color moire phenomenon, which can be caused by displaying stereoscopic images.

### CROSS-REFERENCE TO RELATED APPLICATION

This application claims priority to and the benefit of Korean Patent Application No. 10-2024-0029968, filed on Feb. 29, 2024, the disclosure of which is incorporated herein by reference in its entirety.

### BACKGROUND

### Technical Field

The present disclosure relates to a stereoscopic image display device.

### Description of the Related Art

Recently, as users' demands for realistic images have been increased, stereoscopic image display devices capable of displaying both two-dimensional images and three-dimensional images have been developed. In the stereoscopic image display devices according to the related art, left-eye images and right-eye images are displayed separately through a display panel and the stereoscopic images are separated into multi-views through a lenticular lens disposed on the display panel. Each pixel formed on the display panel displays an image corresponding to a view map assigned according to the multi-view.

The lenticular lens is generally disposed to be slanted at a predetermined angle in a longitudinal direction on the display panel, and in this case, a distortion problem of vertical images occurs. In addition, there is a problem that the lenticular lens magnifies luminance deviation that occurs inside a pixel, and thus the luminance deviation is visible to the user or a pattern is visible to the user's eyes. Accordingly, it would be advantageous to have a stereoscopic image display device that overcomes these and other deficiencies and disadvantages with current solutions.

### BRIEF SUMMARY

The present disclosure is directed to overcoming the above-described problems of the related art.

A stereoscopic image display device according to the present disclosure includes a display panel that displays an image, and a plurality of lenses disposed on the display panel, wherein the display panel includes a plurality of unit pixels including a first pixel, a second pixel, and a third pixel that are disposed in a first direction, the plurality of unit pixels are disposed in a second direction intersecting the first direction, pixels included in each of the plurality of unit pixels are pixels disposed in the second direction to emit light of different colors in the second direction, and the plurality of lenses extend in a third direction intersecting the first direction and the second direction.

The second direction may form a predetermined angle with respect to the third direction.

The first pixel may implement a first color, the second pixel may implement a second color, and the third pixel may implement a third color, the first to third pixels may form a unit having an M×N array in which N pixels are disposed in the first direction and M pixels are disposed in the second direction, the unit may include a first unit having a 1×3 array in which the first pixel, the second pixel, and the third pixel are disposed in the first direction, and a second unit having a 3×3 array in which the first unit is disposed in the second direction, and in the second unit, colors implemented by the pixels disposed in the second direction may be different.

A stereoscopic image display device according to the present disclosure includes a first pixel, a second pixel, and a third pixel that implement a first color, a second color, and a third color, respectively, wherein the first to third pixels form a unit having an M×N array in which N pixels are disposed in a first direction and M pixels are disposed in a second direction intersecting the first direction, the unit includes a first unit having a 1×3 array and a second unit having a 3×3 array in which the first unit is disposed in the second direction, the second unit includes a fifth unit having a 3×1 array, and the colors implemented by the pixels disposed in the second direction in the fifth unit are different.

The stereoscopic image display device may further include a lens disposed to extend in a third direction intersecting the first direction and the second direction.

The lens may be disposed in a direction in which light is emitted from the pixels.

The embodiments of the present disclosure are not limited to the above-described embodiments, and other embodiments that are not mentioned will be able to be clearly understood by those skilled in the art from the following description.

### BRIEF DESCRIPTION OF THE SEVERAL VIEWS OF THE DRAWINGS

FIG. 1 is a schematic exploded view showing a stereoscopic image display device according to one embodiment of the present disclosure.

FIG. 2 is a schematic cross-sectional view of the stereoscopic image display device of FIG. 1.

FIG. 3 is a schematic view showing a configuration of a first substrate of a display panel of the display device of FIG. 1.

FIG. 4 is a view for describing a method for implementing a multi-view in the stereoscopic image display devices of the present disclosure.

FIG. 5 is a view showing an example slanted lens.

FIG. 6 is a view for describing vertical image distortion.

FIG. 7 is a view showing pixels and lenses disposed in the stereoscopic image display device of FIG. 1.

FIG. 8 is a view showing an example vertical lens.

FIG. 9 is a view for describing a color moire phenomenon in a horizontal direction.

FIG. 10 is a view for describing a first rule of a color arrangement according to an embodiment of the present disclosure.

FIG. 11 is a view for describing a second rule of the color arrangement according to an embodiment of the present disclosure.

FIG. 12 is a view for describing a third rule of the color arrangement according to an embodiment of the present disclosure.

FIG. 13 is a schematic plan view showing the display device having the color arrangement according to an embodiment of the present disclosure.

FIG. 14 is a schematic plan view showing the display device having the color arrangement according to an embodiment of the present disclosure.

FIG. 15 is a view for describing a reduction in color moire phenomenon of the display devices of the present disclosure.

FIG. 16 is a view for describing a fourth rule of a color arrangement according to a an embodiment of the present disclosure.

FIG. 17 is a view for describing a fifth rule of the color arrangement according to an embodiment of the present disclosure.

FIG. 18 is a view for describing a sixth rule of the color arrangement according to an embodiment of the present disclosure.

FIGS. 19 to 31 are views for describing features of the color arrangement according to an embodiment of the present disclosure.

FIG. 32 is a schematic plan view showing the display device having the color arrangement according to an embodiment of the present disclosure.

FIGS. 32 to 34 are schematic cross-sectional views showing a stereoscopic image display device according to an embodiment of the present disclosure.

FIGS. 35 to 36 are views showing pixels and lenses disposed in the stereoscopic image display device of FIGS. 32 to 34.

### DETAILED DESCRIPTION

Advantages and features of the present disclosure and methods for achieving them will become clear with reference to embodiments described below in detail in conjunction with the accompanying drawings. The present disclosure is not limited to the embodiments disclosed below but can be implemented in various different forms, and these embodiments are merely provided to make the disclosure of the present disclosure complete and fully inform those skilled in the art to which the present disclosure pertains of the scope of the present disclosure, and the present disclosure is only defined by the scope of the appended claims.

In describing the present disclosure, when it is determined that the detailed description of a related known technology may unnecessarily obscure the gist of the present disclosure, detailed description thereof will be omitted.

When the terms “comprise,” “include,” “have,” and “consist of” described in the present disclosure are used, other parts may be added unless “only” is used. When a component is expressed in the singular, it can be construed as a plurality of components unless specifically stated otherwise.

When the position relationship and interconnection relationship between two components, such as “on,” “above,” “under,” “next to,” “connected or coupled,” “crossing or intersecting,” or the like described, one or more other components may be interposed between the components unless the term “immediately” or “directly” is described.

When the temporal relationship is described using the term “after,” “subsequently,” “then,” “before,” or the like, it may include a non-consecutive case unless the term “immediately” or “directly” is used.

Although the term “first,” “second,” or the like may be used to distinguish components, functions or structures of the components are not limited by the ordinal number or component name added to the front of the component.

The following embodiments may be partially or fully coupled or combined, and various technological interworking and driving are possible. The embodiments may be implemented independently of each other and implemented together in the associated relationship.

In addition, terms (including technical and scientific terms) used in embodiments of the present disclosure may be construed as meaning that may be generally understood by those skilled in the art to which the present disclosure pertains unless explicitly specifically defined and described, and the meanings of the commonly used terms, such as terms defined in a dictionary, may be construed in consideration of contextual meanings of related technologies.

Hereinafter, embodiments of the present disclosure will be described in detail with reference to the accompanying drawings.

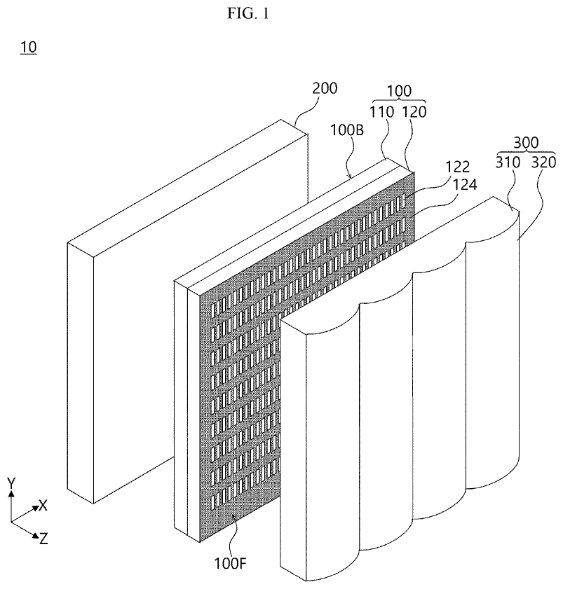

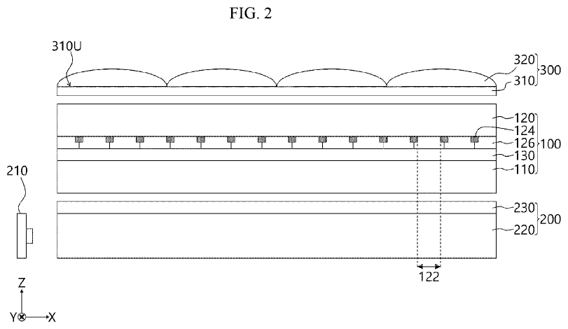

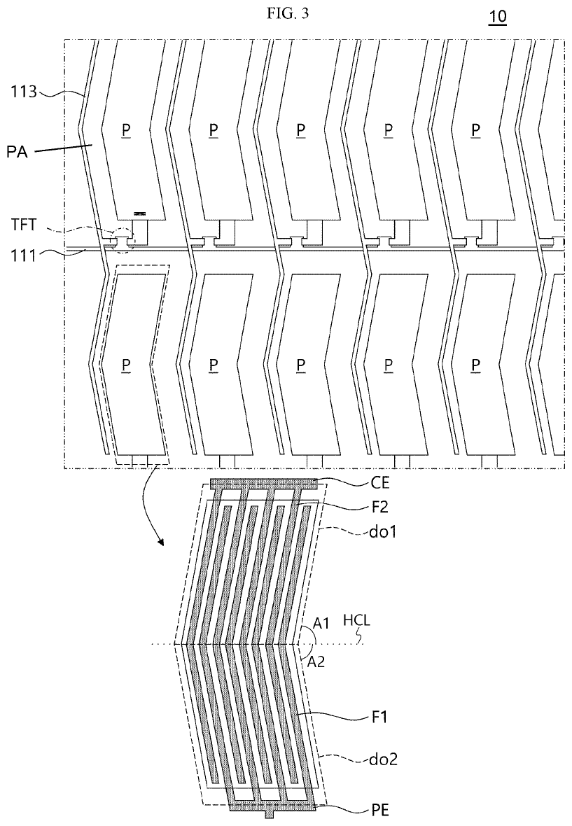

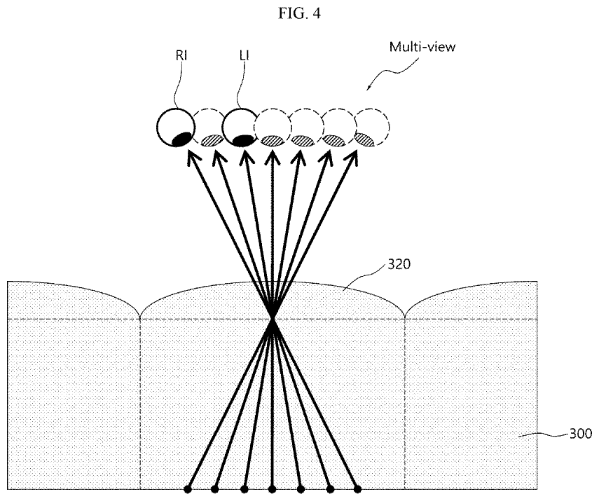

FIG. 1 is a schematic view showing a stereoscopic image display device 10 according to one or more embodiments of the present disclosure. FIG. 2 is a schematic cross-sectional view of the display device 10. FIG. 3 is a schematic view showing a configuration of a first substrate 110 of a display panel 100 of the display device 10. FIG. 4 is a view for describing a method for implementing a multi-view in the stereoscopic image display device 10.

Referring to FIGS. 1 to 4, the stereoscopic image display device 10 may be implemented as a flat panel display device, such as a liquid crystal display (LCD) device, a field emission display (FED) device, a plasma display panel (PDP) display device, or an organic light emitting diode (OLED) display device. For convenience of description, hereinafter, an example in which the stereoscopic image display device 10 is implemented as an LCD device will be described, but the present disclosure is not limited thereto.

The stereoscopic image display device 10 according to one or more embodiments of the present disclosure may include the display panel 100, a backlight unit 200 (or a backlight 200), and a viewing angle control device 300.

The display panel 100 may display images using a plurality of pixels P. The display panel 100 may include the first substrate 110 and a second substrate 120 that are bonded to be opposite to each other with a liquid crystal layer 130 interposed therebetween.

The first substrate 110 is a thin film transistor array substrate including thin film transistors and may include a plurality of gate lines 111, a plurality of data lines 113, a thin film transistor TFT, and a plurality of pixels P. The plurality of gate lines 111 and the plurality of data lines 113 may be arranged to intersect each other on the first substrate 110 to define a plurality of pixel areas PA, as shown in FIG. 3.

The thin film transistor TFT is formed in a transistor area (i.e., within dashed circle in FIG. 3) of the pixel area PA and may be switched on according to a gate signal supplied to the gate line 111, which in turn supplies a data signal supplied to the data line 113 that is provided to a pixel electrode PE. The thin film transistor TFT may include a gate electrode, a semiconductor layer, a source electrode, and a drain electrode. In one embodiment, the thin film transistor TFT may be implemented in a bottom gate structure in which the gate electrode is located under a semiconductor layer or implemented in a top gate structure in which the gate electrode is located above the semiconductor layer.

The plurality of pixels P may display different colors. The plurality of pixels P may include a red pixel that displays red, a green pixel that displays green, and a blue pixel that displays blue, but are not limited thereto. For example, the plurality of pixels P may further include a white pixel that displays white. For example, a pixel that includes a red pixel, a green pixel, and a blue pixel may be referred to as one unit pixel or a pixel assemply.

Each of the plurality of pixels P may include the pixel electrode PE that is connected to the thin film transistor TFT and a common electrode CE, as shown in the detail view of FIG. 3.

The pixel electrode PE may be connected to a source electrode or drain electrode of the thin film transistor TFT to generate an electric field in the liquid crystal layer 130 by the data signal supplied from the thin film transistor TFT. The pixel electrode PE may include a plurality of first fingers F1. The plurality of first fingers F1 may protrude from the pixel electrode PE and extend to be adjacent to the common electrode CE disposed in an upper area of the pixel P.

The common electrode CE may drive liquid crystal molecules of the liquid crystal layer 130 by generating the electric field together with the pixel electrode PE. The common electrode CE may include a plurality of second fingers F2. The plurality of second fingers F2 may protrude from the common electrode CE and extend to be adjacent to the pixel electrode PE disposed in a lower area of the pixel P.

Each of the plurality of second fingers F2 may be disposed between neighboring first fingers F1 in an interlocking and overlapping manner. In other words, the first and second fingers F1, F2 are interdigitated. Therefore, a horizontal electric field may be generated between the pixel electrode PE and the common electrode CE. As shown, the common electrode CE is shown as including a plurality of second fingers F2, but is not necessarily limited thereto. For example, the common electrode CE may be formed to entirely cover a plurality of pixel areas, and in such an example, a vertical electric field may be generated between the pixel electrode PE and the common electrode CE.

The common electrode CE may be formed on the first substrate 110 together with the pixel electrode PE in horizontal electric field driving methods such as an in plane switching (IPS) mode and a fringe field switching (FFS) mode. The common electrode CE may be formed on the second substrate 120 in vertical electric field driving methods such as a twisted nematic (TN) mode and a vertical alignment (VA) mode. A liquid crystal mode of the display panel 100 may be implemented in any liquid crystal mode in addition to the above-described TN mode, VA mode, IPS mode, and FFS mode.

The pixel P may be formed in a multi-domain structure divided into a first domain do1 and a second domain do2 as the pixel electrode PE is formed in a bent shape. The multi-domain structure may control the orientation of liquid crystals differently in the first domain do1 and the second domain do2, and thus there are advantages in which color shift can be minimized and a viewing angle can be increased. In the case of the multi-domain structure, the plurality of first fingers F1 and the plurality of second fingers F2 have a structure bent at the boundary between the first domain do1 and the second domain do2. In other words, a horizontal centerline HCL through the pixels P may define a boundary between the first and second domains do1, do2 with each of the domains do1, do2 having a different angle relative to the horizontal centerline HCL. As shown in FIG. 3, the first domain do1 may be at an angle A1 to the centerline HCL and the second domain do2 may be at an angle A2 to the centerline HCL. The angle A1 may greater than 45 degrees and less than 90 degrees and may be a positive angle relative to the centerline HCL, meaning the angle is measured vertically upward from the centerline HCL. The angle A2 may be greater than 45 degrees and less than 90 degrees but is a negative angle, meaning the angle A2 is measured vertically downward from the centerline HCL. Therefore, the first fingers F1 and the second fingers F2 may be disposed parallel to each other in a specific direction in the first domain do1 or the second domain do2, and more specifically, the first and second fingers F1, F2 in the first domain do1 may be parallel along an axis at the same angle A1 to the centerline HCL and the first and second fingers F1, F2 in the second domain do2 may be parallel along an axis at the same angle A2 to the centerline HCL.

A view map set based on the number of multi-views (or viewing zones) may be assigned to each of the plurality of pixels P.

The second substrate 120 is a color filter array substrate including color filters and may include a black matrix 124 and a color filter 126.

The black matrix 124 may include a plurality of openings 122 each overlapping one of the plurality of pixels P. Each of the plurality of openings 122 defines an opening area of the pixel P, may have a smaller area than the pixel P, and may be formed in a shape that differs from that of the pixel P. A portion of the pixel P may be exposed through the opening 122.

The color filter 126 may be provided in the opening 122 that is not covered by the black matrix 124. The color filter 126 may include a red color filter, a green color filter, and a blue color filter.

The display panel 100 may adjust the transmittance of light incident from the backlight unit 200 by supplying the data signal from a panel driver to the corresponding pixel P to generate an electric field in the liquid crystal layer 130. The display panel 100 may display images according to the view map assigned to each pixel P.

The backlight unit 200 may be disposed on a back or rear surface 100B of the display panel 100 to radiate light to the display panel 100. The backlight unit 200 may include a light source 210, a light guide plate 220 for guiding light from the light source 210 toward the display panel 100, and an optical sheet 230 disposed on the light guide plate 220 to increase light efficiency. The backlight unit 200 may be implemented as a direct type or edge type backlight unit. The light sources 210 of the backlight unit 200 may include any one or more among a hot cathode fluorescent lamp (HCFL), a cold cathode fluorescent lamp (CCFL), an external electrode fluorescent lamp (EEFL), a light emitting diode (LED), and an organic light emitting diode (OLED).

The viewing angle control device 300 may be disposed on the front surface 100F of the display panel 100 and may include a base film 310 and a plurality of lenses 320 provided on an upper surface 310U of the base film 310. The plurality of lenses 320 may be disposed in a direction (e.g., a Z-axis direction) in which light is emitted from the display panel 100.

The plurality of lenses 320 may be formed to be convex from the upper surface 310U of the base film 310 and may extend in a vertical direction. For example, the plurality of lenses 320 may have a semicircular shape or a convex lens-shaped cross section having a predetermined curvature. The plurality of lenses 320 may be lenticular lenses, but are not necessarily limited thereto. The plurality of lenses 320 may be implemented as switchable lenses. The plurality of lenses 320 may be classified into slanted lenses and vertical lenses according to angles formed with the disposed pixels P.

The viewing angle control device 300 may separate images displayed on the plurality of pixels P into a plurality of views (or a plurality of viewing zones). The viewing angle control device 300 may form a viewing zone at an optimal viewing distance by controlling light from the plurality of pixels P. The viewing zone may include a plurality of views (multi-view). Each of the plurality of views may have a diamond shape. Therefore, the plurality of views may be referred to as view diamonds. To allow a person's eyes (left eye and right eye) to view different images, each of the plurality of views may be formed to have a width that is smaller than a distance between the person's eyes.

The viewing angle control device 300 may divide images displayed on the plurality of pixels P into the plurality of views using the plurality of lenses 320. The viewing angle control device 300 may divide the images displayed on the plurality of pixels P included in the lens 320 into a plurality of views corresponding to the view map so that the viewer may view a stereoscopic image in a plurality of viewing zones. In some situations, the viewer may feel the stereoscopic effect due to the binocular disparity between a left eye image LI perceived by a left eye and a right eye image RI perceived by a right eye in a predetermined viewing zone, as shown in FIG. 4.

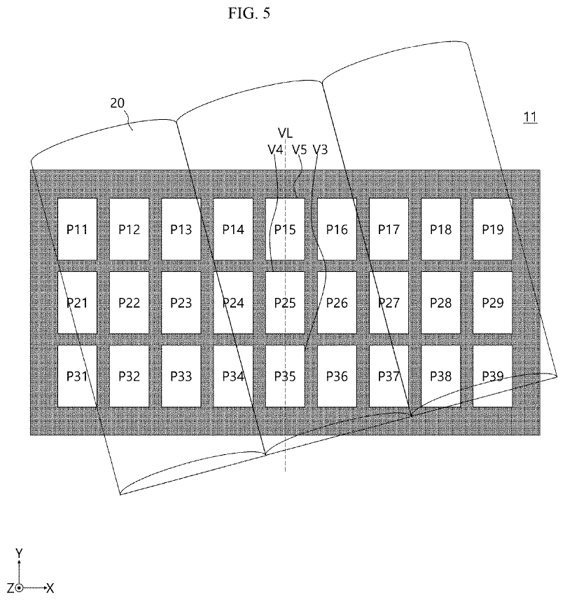

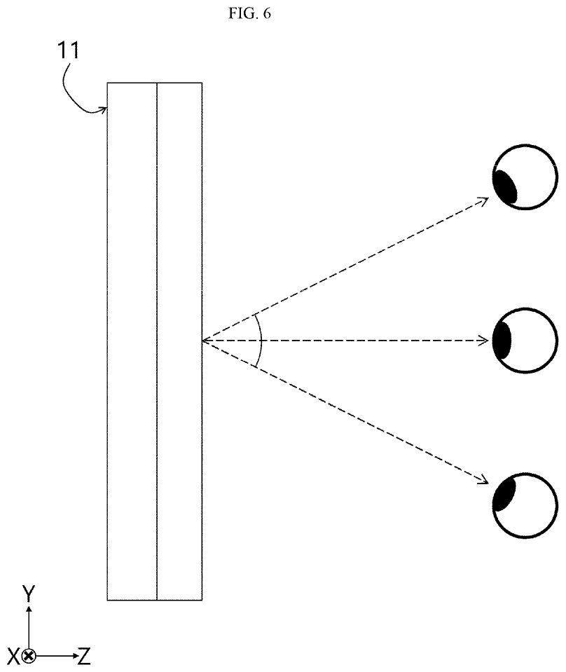

FIG. 5 is a view showing an example slanted lens. FIG. 6 is a view for describing vertical image distortion.

Referring to FIGS. 5 and 6, in a conventional stereoscopic image display device 11, pixels P may be aligned in a straight line in a vertical direction and in a straight line in a horizontal direction, and a plurality of lenses 20 may be disposed in slanted states at predetermined angles relative to the pixels P. As described above, the lens disposed in the slanted state may be referred to as a slanted lens. When the user moves in the vertical direction rather than the horizontal direction while viewing the stereoscopic image displayed on the conventional stereoscopic image display device 11, the user may view different images depending on viewing positions.

The user's eyes may move up and down on one vertical line VL while viewing the images displayed by the pixels P shown in FIG. 6. At this time, the user may view the view images corresponding to different views while moving up and down on the vertical line VL.

When the user's eyes are positioned to look forward, the user may view a fourth view image through pixel P25 corresponding to the fourth view V4. When the user's eyes are positioned to look up or down with respect to looking forward, the user may view a third view image through pixel P35 corresponding to a third view V3 or view a fifth view image through pixel P15 corresponding to a fifth view V5. In the conventional stereoscopic image display device 11, there may be a problem of vertical image distortion caused by the user's eyes moving in the vertical direction because different images are viewed as the user's eyes move. In general, the pixels P in FIG. 5 in a conventional device 11 may be arranged in a matrix with each pixel P in each row and column aligned with the other pixels P in the other rows and columns in the horizontal and vertical directions.

Unlike the conventional stereoscopic image display device 11, in the stereoscopic image display device 10 according to embodiments of the present disclosure, the pixels P may be arranged to be shifted on a horizontal line basis, and the plurality of lenses 320 may be disposed in the vertical direction without being slanted. When the user moves in the vertical direction rather than the horizontal direction while viewing the stereoscopic image displayed on the stereoscopic image display device according to embodiments of the present disclosure, the user may not view different images even when the viewing positions are changed.

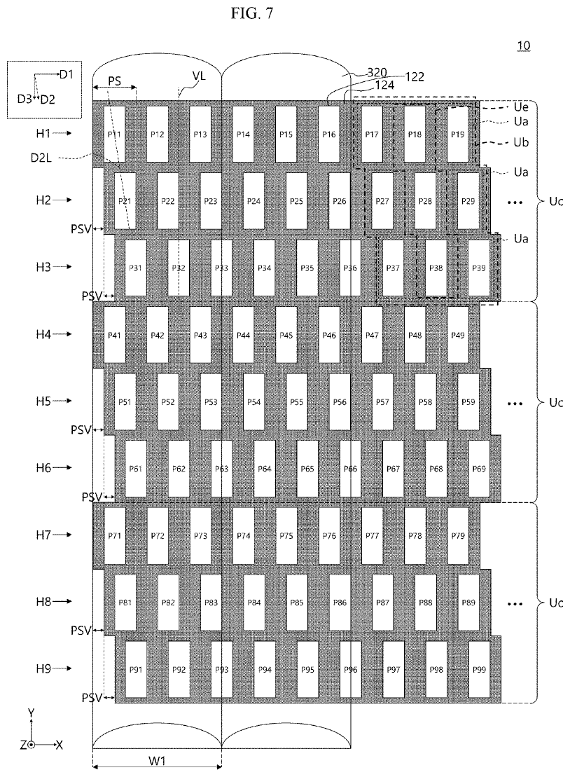

FIG. 7 is a view showing pixels and lenses disposed in the stereoscopic image display device according to embodiments of the present disclosure.

Referring to FIG. 7, and with continuing reference to FIGS. 1-4, the stereoscopic image display device 10 may include a plurality of pixels P. The plurality of pixels P may implement first to third colors C1, C2, and C3.

The black matrix 124 may be disposed between the plurality of pixels P. The black matrix 124 may include a plurality of openings 122 that expose a portion of each of the plurality of pixels P. Each of the plurality of pixels P may include an opening area that overlaps the plurality of openings 122.

The plurality of openings 122 may have a quadrangular shape, but are not limited thereto. The shapes of the plurality of openings 122 may be substantially the same. The plurality of openings 122 may have long sides that are parallel to each other and have the same length and short sides that are parallel to each other and have the same length. The plurality of openings 122 may have the long sides and the short sides that are substantially perpendicular to each other to form a rectangular shape. The plurality of openings 122 may be disposed to be spaced a first distance from each other in a first direction D1. The plurality of openings 122 may be disposed to be spaced a second distance from each other in a third direction D3. The spacing between the openings 122 may generally correspond to the spacing between the pixels P.

Each of the plurality of lenses 320 may be disposed to extend in the third direction D3 (e.g., a Y-axis direction) that intersects the first direction D1. The plurality of lenses 320 may be disposed parallel to one side of the openings 122, for example, the long side of the openings 122. The display device 10 may include a lens disposed to extend in the third direction D3 and pixels (e.g., P11, P21, and P31) disposed in a second direction D2, thereby preventing the vertical image distortion. Specifically, the pixels P may be disposed with each row offset from an adjacent row to avoid vertical image distortion. As shown in FIG. 7, the first horizontal row of pixels P including pixel P11 is disposed aligned with a left boundary of the left lens 320. The next horizontal row of pixels P including pixel P21 is offset and shifted to the right by a distance PSV relative to the first row of pixels P. The third row of pixels P including pixel P31 is further shifted to the right by an additional distance PSV (i.e., 2*PSV from the first row). This pattern repeats with the remaining rows of pixels P in the third direction D3 with the fourth row including pixel P41 aligned with the left side of the lens 320 and so on.

The user's eyes may move up and down on the one vertical line VL while viewing the images displayed by the pixels P. The user may view only the view image corresponding to one pixel P32 while moving up and down on the vertical line VL. Therefore, the stereoscopic image display device 10 can prevent the vertical image distortion even when the user's eyes move in the vertical direction.

A pitch width W1 of each of the plurality of lenses 320 may be determined based on the number of multi-views and pixel size to be implemented by the stereoscopic image display device 10. The pixels P overlapping the plurality of lenses 320 may be assigned the view map according to the multi-view and may display view images according to the assigned view map.

The plurality of pixels P according to an embodiment of the present disclosure are grouped in a unit U or group U that is an M×N array formed by N pixels P disposed in the first direction D1 (e.g., an X-axis direction) (N is a natural number of 1 or more) and M pixels P disposed in the second direction D2 intersecting the first direction D1 (M is a natural number of 1 or more). As will be described below, when horizontal lines H1, H2, . . . are disposed to be shifted by a first distance PSV in the first direction D1, the second direction D2 may be a direction that forms a predetermined angle with respect to both the X-axis direction and the Y-axis direction. For example, the second direction D2 may be substantially parallel to a virtual line D2L connecting centers of pixel P21 disposed on a second horizontal line and pixel P11 corresponding to pixel 21 and disposed on a first horizontal line. The center of the pixel P21 disposed on the second horizontal line and the center of the pixel P11 disposed on the corresponding first horizontal line may be disposed to be spaced the first distance PSV in the first direction D1 from each other. Since the center of a pixel (e.g., P17) disposed on any one horizontal line (e.g., H1) is spaced the first distance PSV in the first direction D1 from the center of pixel P27 corresponding to the pixel on another horizontal line (e.g., H2) in a c^{th} unit Uc, the second direction D2 may be a derived direction. In other words, the line D2L is drawn through a center of each corresponding pixel in each unit U of three rows (or other selected number of rows) where each successive row is shifted by a distance PSV from the previous row.

For example, an a^{th} unit Ua may have a 1×3 pixel array formed by three pixels P17, P18, and P19 disposed in the first direction D1 and one pixel P17 disposed in the second direction D2. For example, another a^{th} unit Ua may have the 1×3 array formed by three pixels P27, P28, and P29 disposed in the first direction D1 and one pixel P27 disposed in the second direction D2. For example, another a^{th} unit Ua may have the 1×3 array formed by three pixels P37, P38, and P39 disposed in the first direction D1 and one pixel P37 disposed in the second direction D2.

For example, a b^{th} unit Ub may have the 3×3 array formed by three pixels P17, P18, and P19 disposed in the first direction D1 and three pixels P17, P27, and P37 disposed in the second direction D2. In other words, the 3×3 array of the unit Ub may include pixels P17, P18, P19, P27, P28, P29, P37, P38, and P39. Other arrays may be similar.

For example, an b^{th} unit Ub may include an e^{th} unit Ue having the 3×1 array formed by one pixel P18 disposed in the first direction D1 and three pixels P18, P28, and P38 disposed in the second direction D2. In one embodiment, since the b^{th} unit Ub has the 3×3 array, the b^{th} unit Ub may include three types of e^{th} units Ue.

For example, a c^{th} unit Uc may have the 3×9 array formed by nine pixels P11, P12, P13, P14, P15, P16, P17, P18, and P19 disposed in the first direction D1 and three pixels P11, P21, and P31 disposed in the second direction D2. In an embodiment, the first digit in an “array” as described above corresponds to the number of rows in the array and the second digit corresponds to the number of columns in the array. Thus, for example, a “3×9” array includes three rows of pixels P in the second direction D2 and nine columns of pixels P in the first direction D1. Other arrays may be similar.

The display panel may include horizontal lines H1, H2, H3, H4, . . . . The horizontal lines H1, H2, H3, and H4 may have the 1×N array formed by N pixels P11, P12, P13, . . . , PIN disposed in the first direction D1 and one pixel P11 or one row of pixels P disposed in the second direction D2.

The number of horizontal lines H1, H2, H3, H4, . . . and the number N of pixels P disposed on each of the horizontal lines H1, H2, H3, and H4 may be changed depending on the number of multi-views to be implemented by the stereoscopic image display device 10.

Pixels ([P11, P12, P13, P21, P22, P23, P31, P32, P33], [P14, P15, P16, P24, P25, P26, P34, P35, P36], or [P17, P18, P19, P27, P28, P29, P37, P38, P39]) included in the b^{th} unit Ub may be assigned the view map based on the number of multi-views. The view map may be set to the number of pixels P included in the b^{th} unit Ub, such as 9 views. The pixels P included in the b^{th} unit Ub may display images for different views.

The first pixel P11 of the first horizontal line H1 may correspond to the first view and display the first view image in the first viewing zone corresponding to the first view. The first pixel P21 of the second horizontal line H2 may correspond to the second view and display the second view image in the second viewing zone corresponding to the second view. The first pixel P31 of the third horizontal line H3 may correspond to the third view and display the third view image in the third viewing zone corresponding to the third view.

The second pixels P12, P22, and P32 of each of the first to fourth horizontal lines H1, H2, H3, and H4 may correspond to the fourth to sixth views, and the third pixels P13, P23, and P33 corresponding to each of the first to fourth horizontal lines H1, H2, H3, and H4 may correspond to the seventh to ninth views.

In the plurality of pixels P according to embodiments of the present disclosure, the pixels P disposed on each of the N horizontal lines may be arranged to be shifted by the first distance PSV in the horizontal direction.

For example, the N pixels P21, P22, P23, . . . disposed on the second horizontal line H2 may be arranged to be shifted by the first distance PSV in the first direction with respect to the pixels P disposed on the first horizontal line H1.

In addition, pixels disposed on an (N+1)^{th} horizontal line may be arranged to be shifted by the first distance PSV in the first direction with respect to pixels corresponding one-to-one to the pixels and disposed on an N^{th} horizontal line.

For example, the pixel P21 disposed on the second horizontal line H2 may be arranged to be shifted by the first distance PSV in the first direction D1 with respect to the pixel P11 corresponding to the pixel P21 and disposed on the first horizontal line H1. For example, the pixel P22 disposed on the second horizontal line H2 may be arranged to be shifted by the first distance PSV in the first direction D1 with respect to the pixel P12 corresponding to the pixel P22 and disposed on the first horizontal line H1.

As shown, three horizontal lines included in the c^{th} unit Uc are present, but the present disclosure is not limited thereto. The c^{th} unit Uc may include a plurality of horizontal lines.

The first distance PSV may be determined based on the size of the pixel P. For example, the first distance PSV may correspond to 1/Q of a horizontal length PS of the pixel P. The Q may indicate the number of horizontal lines H1, H2, and H3 included in the c^{th} unit Uc. For example, when the c^{th} unit Uc includes three horizontal lines H1, H2, and H3, Q is equal to three and the first distance PSV may correspond to ⅓ of the horizontal length PS of the pixel P. Meanwhile, the horizontal length PS of the pixel P may include both an opening area of the pixel P that overlaps the opening 122 and a non-opening area covered by the black matrix 124. The horizontal length PS of the pixel P may be substantially the same as a horizontal length between the center of one pixel P and the center of another neighboring pixel P in the same row or along the same horizontal line.

Since the pixels P included in the same c^{th} unit Uc are arranged to be shifted on a horizontal line basis, in the stereoscopic image display device 10, it is possible to prevent the vertical image distortion because the horizontal shift between each row accounts for variations in the perceived image in the vertical direction as a user's eye moves up and down the display panel.

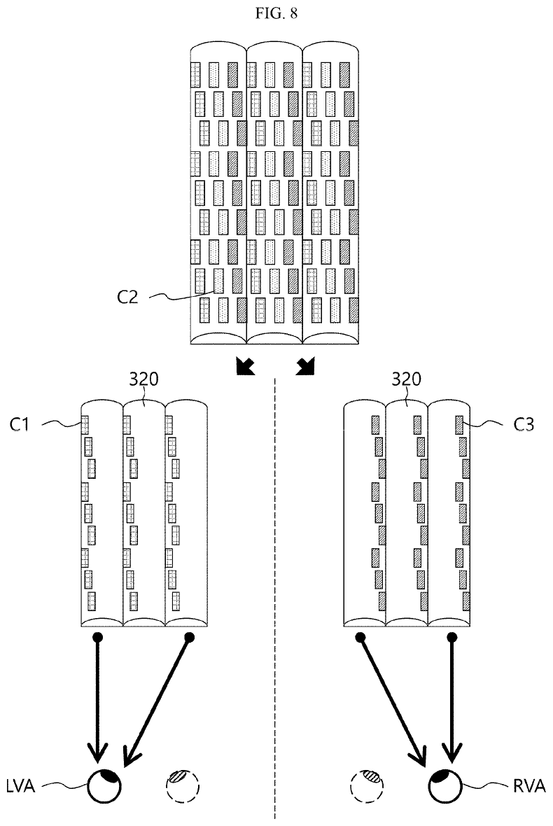

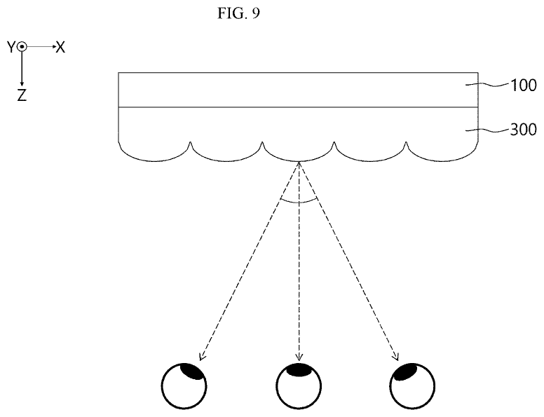

FIG. 8 is a view showing an example vertical lens. FIG. 9 is a view for describing a color moire phenomenon in a horizontal direction.

Referring to FIGS. 8 and 9, when a vertical lens is used rather than a slanted lens that is tilted at a predetermined angle with respect to the arrangement direction of pixels disposed on the display panel, the color moire phenomenon may occur. For example, the description in which vertical image distortion is prevented by the vertical lens will be made below, and colors of the pixels disposed in each lens 320 may be arranged in the order of a first color C1, a second color C2, and a third color C3. Therefore, since a pattern of the first color C1 and a pattern of the third color C3 may be repeatedly shown, wavy patterns may be visible due to optical constructive interference, thereby causing the moire phenomenon.

Since the color moire phenomenon may occur even when the vertical lens and the pixel arrangement as the shifted arrangement are implemented, it is beneficial to prevent the color moire phenomenon and increase the visibility of the display device. By allowing the user's eyes to view different colors through the lens in a first, second, or third direction, in the stereoscopic image display device 10, it is possible to increase the visibility of the display device or otherwise improve characteristics of the image(s) displayed by the display device 10.

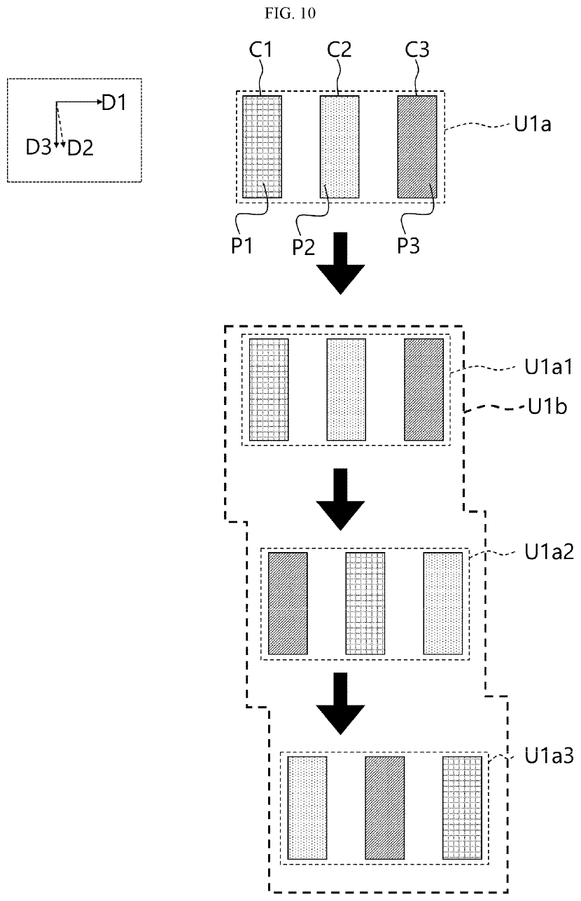

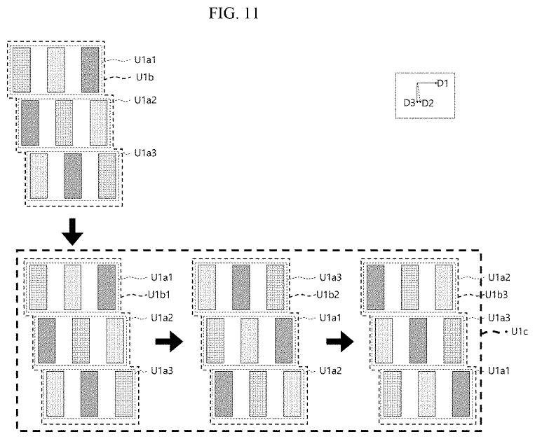

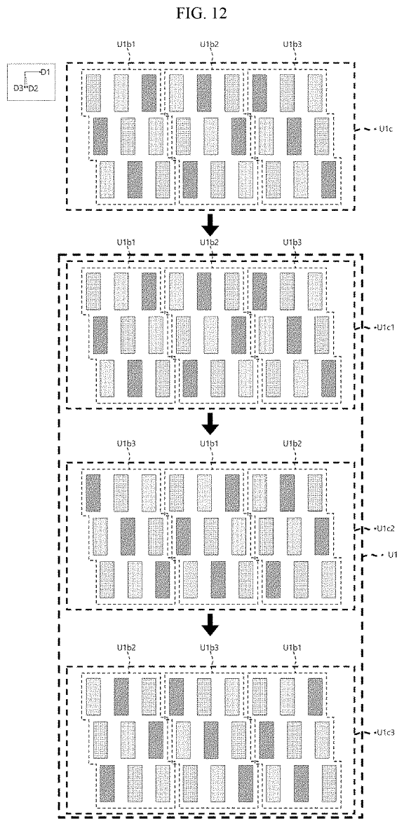

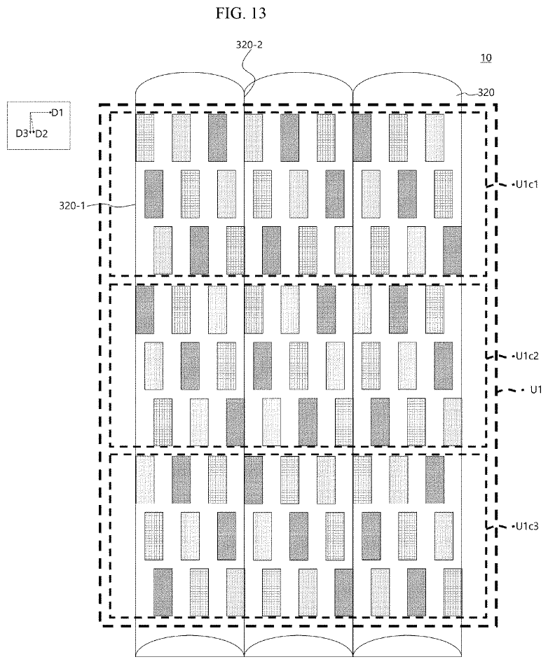

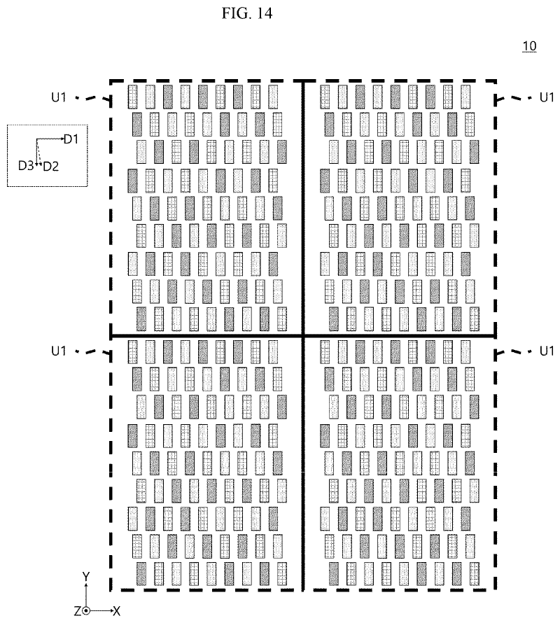

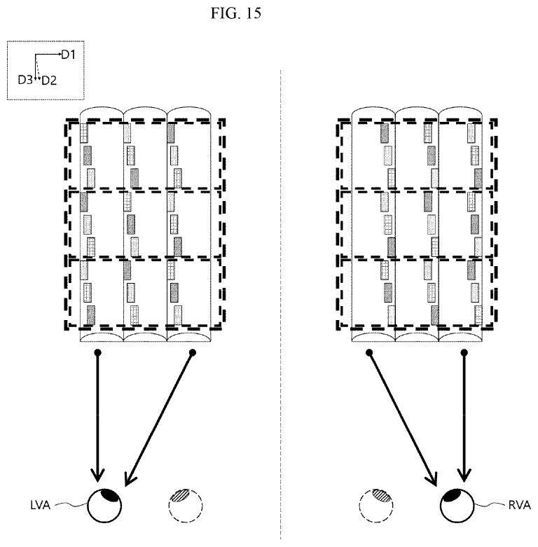

FIG. 10 is a view for describing a first rule of a color arrangement according to an embodiment of the present disclosure. FIG. 11 is a view for describing a second rule of the color arrangement according to an embodiment of the present disclosure. FIG. 12 is a view for describing a third rule of the color arrangement according to an embodiment of the present disclosure. FIG. 13 is a schematic plan view showing the display device having the color arrangement according to an embodiment of the present disclosure. FIG. 14 is a schematic plan view showing the display device having the color arrangement according to an embodiment of the present disclosure. FIG. 15 is a view for describing a reduction in color moire phenomenon of the display device.

Referring to FIG. 10, the display device according to an embodiment of the present disclosure may include a first pixel P1 implementing the first color C1, a second pixel P2 implementing the second color C2, and a third pixel P3 implementing the third color C3. The first to third pixels P may each be provided as a plurality of pixels. The first color C1, the second color C2, and the third color C3 may be any one color selected from the group consisting of red, green, and blue in a non-overlapping manner. For example, the first color C1 may be red, the second color C2 may be green, and the third color C3 may be blue. In one embodiment, for example, a set of pixels including the first pixel, the second pixel, and the third pixel may be referred to as one unit pixel.

In one embodiment, the first color C1, the second color C2, and the third color C3 may be different colors. In other words, the first color C1 and the second color C2 may have different colors, the first color C1 and the third color C3 may have different colors, and the second color C2 and the third color C3 may have different colors. In one embodiment, colors implemented by the first pixel, the second pixel, and the third pixel may be different.

The plurality of first to third pixels may form a unit having the M×N array in which N pixels are disposed in the first direction D1 and M pixels are disposed in the second direction D2 intersecting the first direction D1. In the present disclosure, the term “unit” is a set indicating only the number of disposed pixels. Unless it is stated that specific pixels are disposed sequentially or repeatedly, the term “unit” indicates only included pixels or the number of pixels according to the arrangement of the unit, and is not intended to limit the specific arrangement order thereof nor their location in the display.

The unit pixels may include a first unit U1a, a second unit U1b, a third unit U1c, and a fourth unit U1.

For example, the plurality of first to third pixels may form the first unit U1a having the 1×3 array in which the first, second, and third pixels are arranged in the first direction D1.

The first unit U1a may include a 11 unit U1a1, a 12 unit U1a2, and a 13 unit U1a3. The 11 unit U1a1 may include the first pixel, the second pixel, and the third pixel that are sequentially disposed in the first direction D1. The 12 unit U1a2 may include the third pixel, the first pixel, and the second pixel that are sequentially disposed in the first direction D1. The 13 unit U1a3 may include the second pixel, the third pixel, and the first pixel that are sequentially disposed in the first direction D1. Each of the 11 unit, 12 unit, and 13 unit may also be referred to as sub-units U1a1, U1a2, U1a3. The sub-units U1a1, U1a2, U1a3 may include pixels disposed on different horizontal lines in some embodiments.

For example, the plurality of first to third pixels may form the second unit U1b having the 3×3 array in which the 11 unit U1a1, the 12 unit U1a2, and the 13 unit U1a3 are disposed in the second direction D2, as shown in FIG. 10.

Referring to FIG. 11, the second unit U1b may include a 21 unit U1b1, a 22 unit U1b2, and a 23 unit U1b3. The 21 unit U1b1 may include the 11 unit U1a1, the 12 unit U1a2, and the 13 unit U1a3 that are sequentially disposed in the second direction D2. The 22 unit U1b2 may include the 13 unit U1a3, the 11 unit U1a1, and the 12 unit U1a2 that are sequentially disposed in the second direction D2. The 23 unit U1b3 may include the 12 unit U1a2, the 13 unit U1a3, and the 11 unit U1a1 that are sequentially disposed in the second direction D2. Accordingly, the second unit U1b may be a 9×9 pixel array that includes different pixels in different arrangements according to the above-described units U1a1, U1a2, and U1a3. For example, in FIG. 11, the unit U1b1 includes U1a1, U1a2, and U1a3 sub-units in sequential order in the second direction D2. The unit U1b2 includes units U1a3, U1a1, and U1a2 in sequential order in the second direction D2. Finally, the unit U1b3 includes U1a2, U1a3, and U1a1 sub-units in sequential order in the second direction D2.

Colors implemented by the pixels disposed in the second direction D2 in the second unit U1b may be different. For example, the second unit U1b may include the first pixel, the third pixel, and the second pixel that are disposed in the second direction D2. The second unit U1b may include the second pixel, the first pixel, and the third pixel that are disposed in the second direction D2. The third unit U1c may include the third pixel, the second pixel, and the first pixel that are disposed in the second direction D2.

For example, the plurality of first to third pixels may form the third unit having the 3×9 array in which the 21 unit U1b1, the 22 unit U1b2, and the 23 unit U1b3 are disposed in the first direction D1.

Referring to FIG. 12, the third unit U1c may include a 31 unit U1c1, a 32 unit U1c2, and a 33 unit U1c3. The 31 unit U1c1 may include the 21 unit U1b1, the 22 unit U1b2, and the 23 unit U1b3 that are sequentially disposed in the first direction D1. The 32 unit U1c2 may include the 23 unit U1b3, the 21 unit U1b1, and the 22 unit U1b2 that are sequentially disposed in the first direction D1. The 33 unit U1c3 may include the 22 unit U1b2, the 23 unit U1b3, and the 21 unit U1b1 that are sequentially disposed in the first direction D1. As shown in FIG. 12, each of the units U1c1, U1c2, and U1c3 have a different arrangement of subunits U1b1, U1b2, and U1b3 disposed in sequential order in the first direction D1.

For example, the plurality of first to third pixels may form the fourth unit U1 in which the 31 unit U1c1, the 32 unit U1c2, and the 33 unit U1c3 are disposed in the third direction D3. In other words, the fourth unit U1 is a combination of the units U1c1, U1c2, and U1c3.

Referring to FIG. 13, the fourth unit U1 may include the 31 unit U1c1, the 32 unit U1c2, and the 33 unit U1c3 that are sequentially disposed in the third direction D3.

In one embodiment, the display device 10 may include a plurality of lenses 320. Each lens 320 may extend in the third direction D3, meaning a length direction or direction of a longest dimensions of the lenses 320 is in the third direction D3. The lenses 320 may also have a width or pitch W in the first direction D2 and a thickness in a Z direction (into and out of the page). The pitch width of each of the plurality of lenses 320 may correspond to widths of three pixels (e.g., the first pixel, the second pixel, and the third pixel) disposed in the first direction D1, but is not limited thereto. For example, the pitch width may correspond to widths of six pixels (e.g., the first pixel, the second pixel, the third pixel, the second pixel, the third pixel, and the first pixel) disposed in the first direction D1. As described above, the width of the pixel may include both a width of the opening area and a width of the black matrix and/or bank disposed to surround the opening area in an area adjacent to the opening area, but is not limited thereto. For example, a first end 320-1 of the lens 320 in the first direction D1 may overlap the opening area, and the other second end 320-2 of the lens 320 in the first direction D1 may overlap the black matrix area. The first and second ends 320-1, 320-2 are left and right side surfaces on opposite sides of the width direction of the lenses 320 in an embodiment. Conversely, the first end of the lens 320 in the first direction D1 may overlap the black matrix area, and the other second end of the lens 320 in the first direction D1 may overlap the opening area.

The lens 320 may be disposed in a direction (e.g., the Z-axis direction) in which light is emitted from the pixel.

Referring to FIG. 14, in one embodiment, the display device 10 may have the fourth unit U1 repeatedly disposed in the first direction D1. The display device may have the fourth unit U1 repeatedly disposed in the third direction D3. Accordingly, while the components, units, or sub-units described above may vary for each component part of a respective unit U1, the entire units U1 are repeated in the first and third direction D1, D3 such that the units U1 may have the same configuration of sub-units as other units U1 across the display device 10.

Referring to FIG. 15, in the color arrangement such as that of the display device 10, the arrangement of colors viewed at a left viewing angle LVA may differ from the arrangement of colors viewed at a right viewing angle RVA. For example, the arrangement of colors viewed at the left viewing angle LVA may be the first color, the third color, and the second color in the second direction D2, and the arrangement of colors viewed at the right viewing angle RVA may be the third color, the second color, and the first color in the second direction D2. In one embodiment, the arrangement of the colors C1, C2, and C3 viewed at the left viewing angle LVA may not be shown differently and consecutively by being evenly mixed in the first, second, and third directions D1, D2, and D3. In addition, the arrangement of the colors C1, C2, and C3 viewed at the right viewing angle RVA may not be shown differently and consecutively by being evenly mixed in the first, second, and third directions D1, D2, and D3. Such advantages are achieved by the arrangement of the pixels in each sub-unit as well as the units generally, as well as the horizontal shift between rows of pixels. Therefore, it is possible to reduce the color moire phenomenon of the display device.

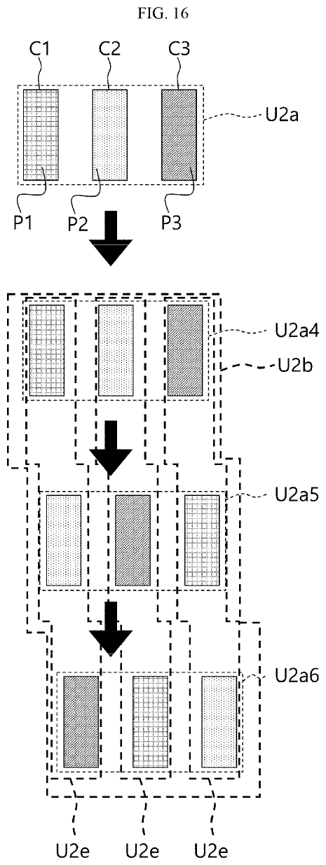

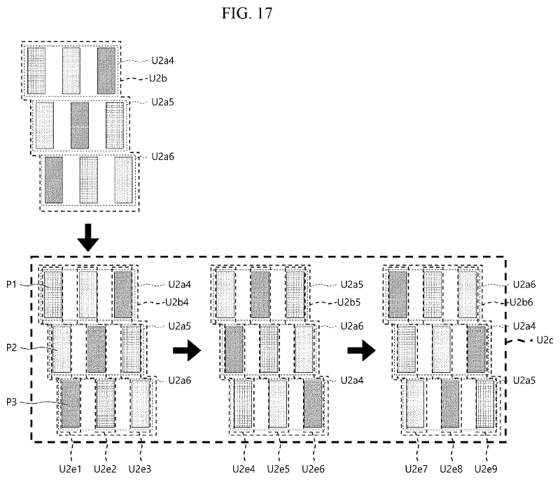

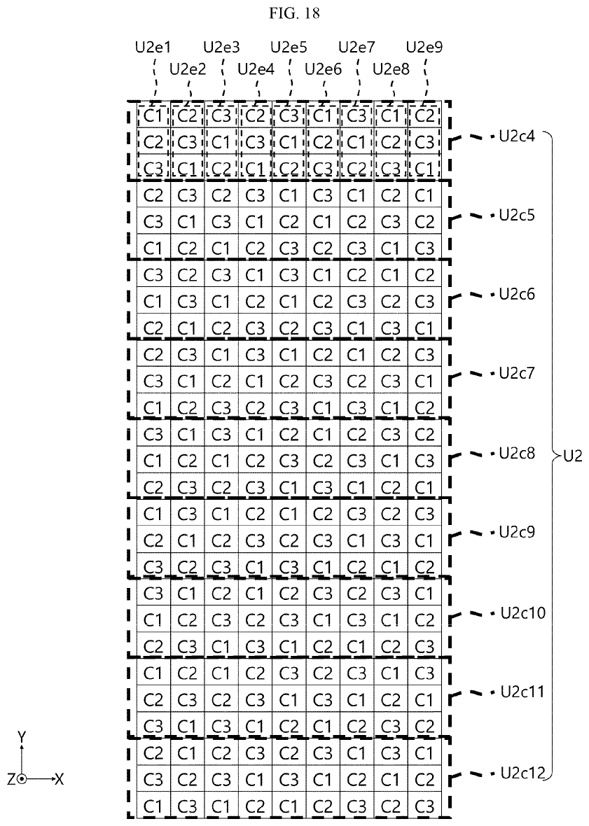

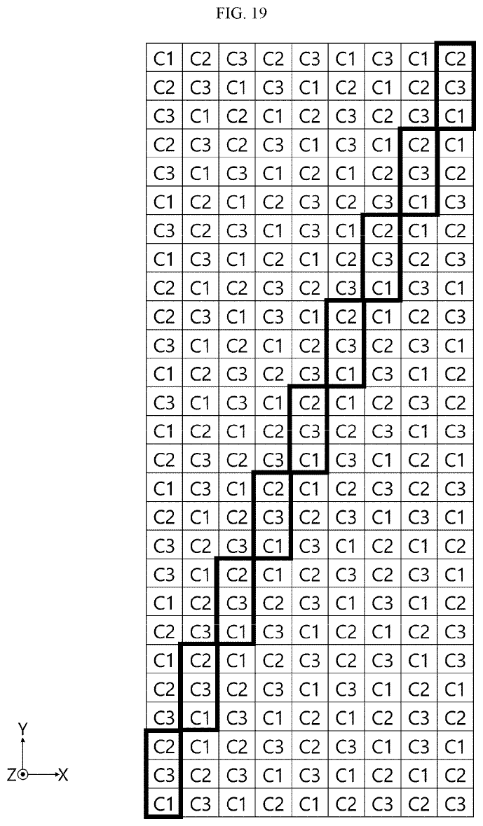

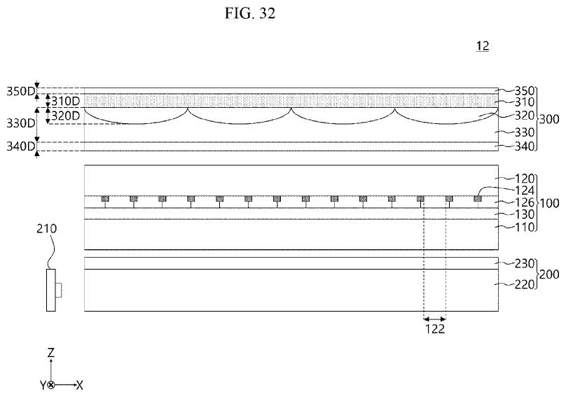

FIG. 16 is a view for describing a fourth rule of a color arrangement according to an embodiment of the present disclosure. FIG. 17 is a view for describing a fifth rule of the color arrangement according to an embodiment of the present disclosure. FIG. 18 is a view for describing a sixth rule of the color arrangement according to an embodiment of the present disclosure. FIGS. 19 to 31 are views for describing features of the color arrangement according to an embodiment of the present disclosure. FIG. 32 is a schematic plan view showing the display device 10 having the color arrangement according to an embodiment of the present disclosure.

Referring to FIG. 16, the plurality of first to third pixels P1-P3 according to an embodiment of the present disclosure may form a unit having the M×N array in which N pixels are disposed in the first direction D1 and M pixels are disposed in the second direction D2 intersecting the first direction D1. The pixels P1-P3 implement the colors C1-C3.

The unit may include a first unit U2a, a second unit U2b, a third unit U2c, a fifth unit U2e, and a sixth unit U2.

For example, the plurality of first to third pixels may form the first unit U2a having the 1×3 array in which the first, second, and third pixels are arranged in the first direction D1.

The first unit U2a may include a 14 unit U2a4, a 15 unit U2a5, and a 16 unit U2a6. The 14 unit U2a4 may include the first pixel P1, the second pixel P2, and the third pixel P3 that are sequentially disposed in the first direction D1. The 15 unit U2a5 may include the second pixel P2, the third pixel P3, and the first pixel P1 that are sequentially disposed in the first direction D1. The 16 unit U2a6 may include the third pixel P3, the first pixel P1, and the second pixel P2 that are sequentially disposed in the first direction D1.

For example, the plurality of first to third pixels P1-3 may form the second unit U2b having the 3×3 array in which the 11 unit, the 12 unit, and the 13 unit are disposed in the second direction D2.

The second unit U2b may include a 24 unit U2b4, a 25 unit U2b5, and a 26 unit U2b6. The 24 unit U2b4 may include the 14 unit U2a4, the 15 unit U2a5, and the 16 unit U2a6 that are sequentially disposed in the second direction D2. The 25 unit U2b5 may include the 15 unit U2a5, the 16 unit U2a6, and the 14 unit U2a4 that are sequentially disposed in the second direction D2. The 26 unit U2b6 may include the 16 unit U2a6, the 14 unit U2a4, and the 15 unit U2a5 that are sequentially disposed in the second direction D2.

Colors implemented by the pixels disposed in the second direction D2 in the second unit U2b may be different. For example, the second unit U2b may include the first pixel P1, the second pixel P2, and the third pixel P3 that are disposed in the second direction D2. The second unit U2b5 may include the second pixel P2, the third pixel P3, and the first pixel P1 that are disposed in the second direction D2. The third unit U2b6 may include the third pixel, the first pixel, and the second pixel that are disposed in the second direction D2. The third unit U2c includes the sub-units U2b4, U2b5, and U2b6, as shown in FIG. 17.

For example, the plurality of first to third pixels P1-P3 may form the fifth unit U2e having the 3×1 array in which the first pixel P1, the second pixel P2, and the third pixel P3 are disposed in the second direction D2.

Referring to FIG. 17, the fifth unit U2e may include a 51 unit U2e1 to a 59 unit U2e9.

The 24 unit U2b4 may include the 51 unit U2e1, the 52 unit U2e2, and the 53 unit U2e3.

The 51 unit U2e1 may include the first pixel P1, the second pixel P2, and the third pixel P3 that are sequentially disposed in the second direction D2. The 52 unit U2e2 may include the second pixel P2, the third pixel P3, and the first pixel P1 that are sequentially disposed in the second direction D2. The 53 unit U2e3 may include the third pixel P3, the first pixel P1, and the second pixel P2 that are sequentially disposed in the second direction D2.

The 25 unit U2b5 may include a 54 unit U2e4, a 55 unit U2e5, and a 56 unit U2e6.

The 54 unit U2e4 may include the second pixel P2, the third pixel P3, and the first pixel P1 that are sequentially disposed in the second direction D2. The 55 unit U2e5 may include the third pixel P3, the first pixel P1, and the second pixel P2 that are sequentially disposed in the second direction D2. The 56 unit U2e6 may include the first pixel P1, the second pixel P2, and the third pixel P3 that are sequentially disposed in the second direction D2.

The 26 unit U2b6 may include a 57 unit U2e7, a 58 unit U2e8, and a 59 unit U2e9.

The 57 unit U2e7 may include the third pixel P3, the first pixel P1, and the second pixel P2 that are sequentially disposed in the second direction D2. The 58 unit U2e8 may include the first pixel P1, the second pixel P2, and the third pixel P3 that are sequentially disposed in the second direction D2. The 59 unit U2e9 may include the second pixel P2, the third pixel P3, and the first pixel P1 that are sequentially disposed in the second direction D2.

For example, the plurality of first to third pixels P1-P3 may form the third unit U2c having the 3×9 array in which the 51 unit U2e1, the 52 unit U2e2, the 53 unit U2e3, the 54 unit U2e4, the 55 unit U2e5, the 56 unit U2e6, the 57 unit U2e7, the 58 unit U2e8, and the 59 unit U2e9 are disposed in the first direction D1.

Referring to FIG. 18, the third unit U2c may include a 34 unit U2c4, a 35 unit U2c5, a 36 unit U2c6, a 37 unit U2c7, a 38 unit U2c8, a 39 unit U2c9, a 310 unit U2c10, a 311 unit U2c11, and a 312 unit U2c12.

The 34 unit U2c4 may include the 51 unit U2e1, the 52 unit U2e2, the 53 unit U2e3, the 54 unit U2e4, the 55 unit U2e5, the 56 unit U2e6, the 57 unit U2e7, the 58 unit U2e8, and the 59 unit U2e9 that are sequentially disposed in the first direction D1.

The 35 unit U2c5 may include the 52 unit U2e2, the 53 unit U2e3, the 54 unit U2e4, the 55 unit U2e5, the 56 unit U2e6, the 57 unit U2e7, the 58 unit U2e8, the 59 unit U2e9, and the 51 unit U2e1 that are sequentially disposed in the first direction D1.

The 36 unit U2c6 may include the 53 unit U2e3, the 54 unit U2e4, the 55 unit U2e5, the 56 unit U2e6, the 57 unit U2e7, the 58 unit U2e8, the 59 unit U2e9, the 51 unit U2e1, and the 52 unit U2e2 that are sequentially disposed in the first direction D1.

The 37 unit U2c7 may include the 54 unit U2e4, the 55 unit U2e5, the 56 unit U2e6, the 57 unit U2e7, the 58 unit U2e8, the 59 unit U2e9, the 51 unit U2e1, the 52 unit U2e2, and the 53 unit U2e3 that are sequentially disposed in the first direction D1.

The 38 unit U2c8 may include the 55 unit U2e5, the 56 unit U2e6, the 57 unit U2e7, the 58 unit U2e8, the 59 unit U2e9, the 51 unit U2e1, the 52 unit U2e2, the 53 unit U2e3, and the 54 unit U2e4 that are sequentially disposed in the first direction D1.

The 39 unit U2c9 may include the 56 unit U2e6, the 57 unit U2e7, the 58 unit U2e8, the 59 unit U2e9, the 51 unit U2e1, the 52 unit U2e2, the 53 unit U2e3, the 54 unit U2e4, and the 55 unit U2e5 that are sequentially disposed in the first direction D1.

The 310 unit U2c10 may include the 57 unit U2e7, the 58 unit U2e8, the 59 unit U2e9, the 51 unit U2e1, the 52 unit U2e2, the 53 unit U2e3, the 54 unit U2e4, the 55 unit U2e5, and the 56 unit U2e6 that are sequentially disposed in the first direction D1.

The 311 unit U2c11 may include the 58 unit U2e8, the 59 unit U2e9, the 51 unit U2e1, the 52 unit U2e2, the 53 unit U2e3, the 54 unit U2e4, the 55 unit U2e5, the 56 unit U2e6, and the 57 unit U2e7 that are sequentially disposed in the first direction D1.

The 312 unit U2c12 may include the 59 unit U2e9, the 51 unit U2e1, the 52 unit U2e2, the 53 unit U2e3, the 54 unit U2e4, the 55 unit U2e5, the 56 unit U2e6, the 57 unit U2e7, and the 58 unit U2e8 that are sequentially disposed in the first direction D1.

For example, the plurality of first to third pixels P1-P3 may form the sixth unit U2 in which the 34 unit U2c4, the 35 unit U2c5, the 36 unit U2c6, the 37 unit U2c7, the 38 unit U2c8, the 39 unit U2c9, the 310 unit U2c10, the 311 unit U2c11, and the 312 unit U2c12 are disposed in the third direction D3.

The sixth unit U2 may include the 34 unit U2c4, the 35 unit U2c5, the 36 unit U2c6, the 37 unit U2c7, the 38 unit U2c8, the 39 unit U2c9, the 310 unit U2c10, the 311 unit U2c11, and the 312 unit U2c12 that are sequentially disposed in the third direction D3.

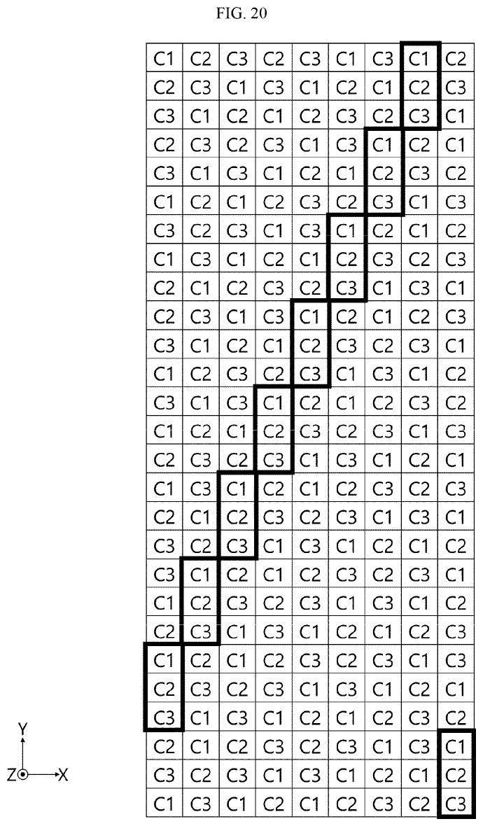

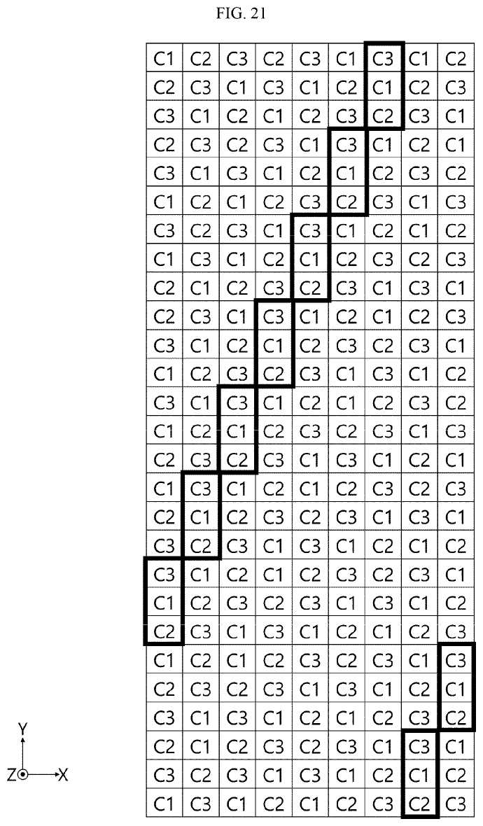

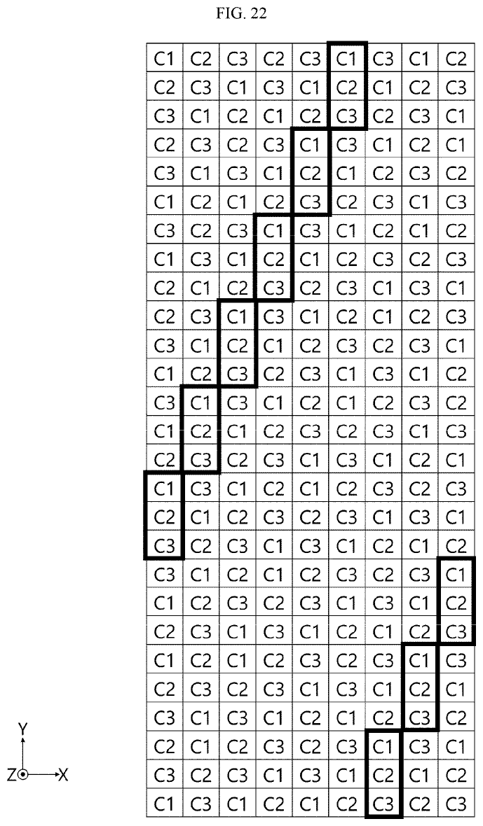

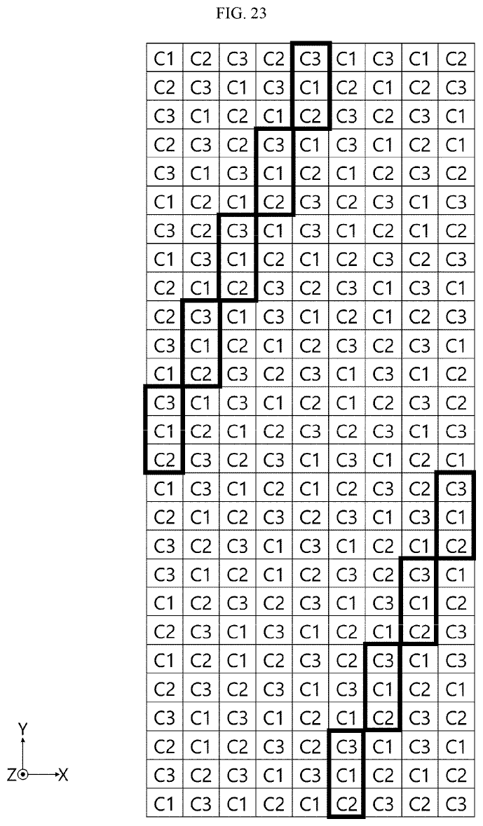

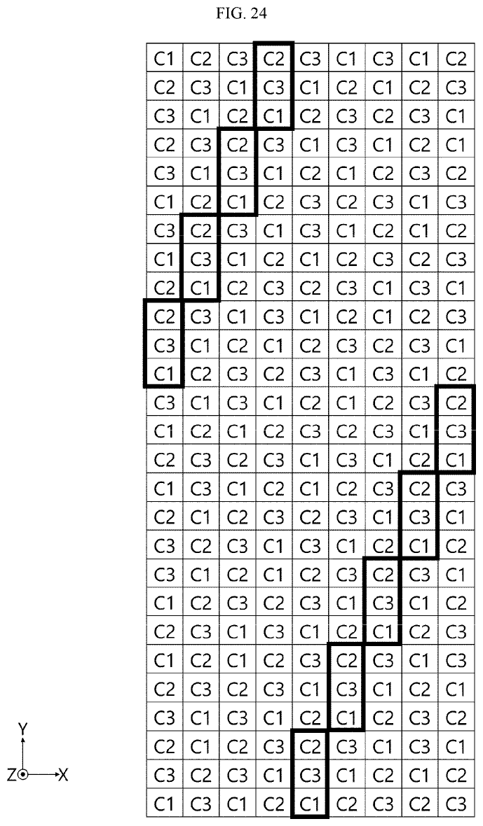

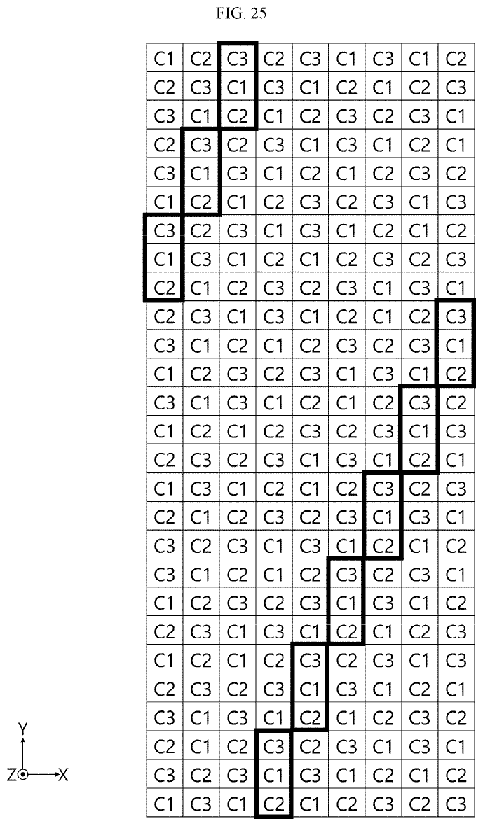

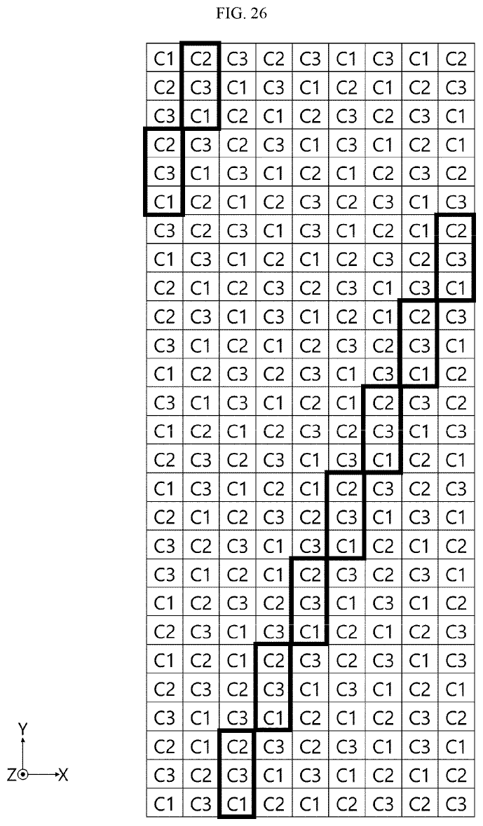

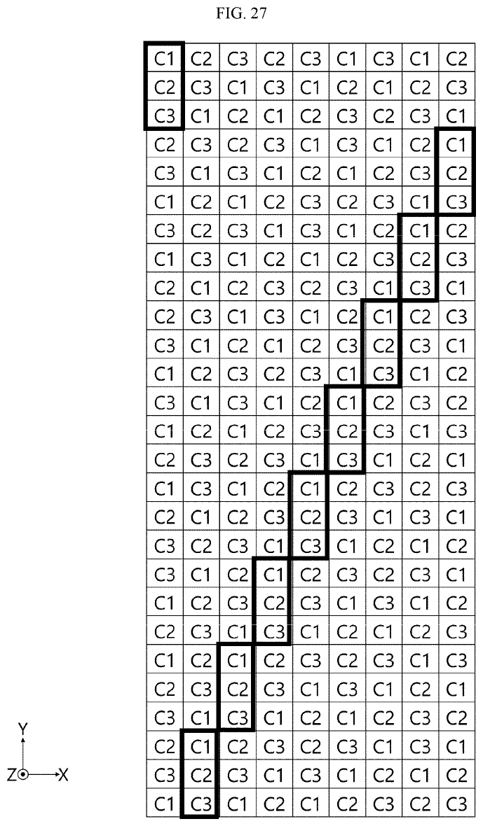

FIG. 19 is a view showing the feature that the 59 unit is repeated for each unit included in the third unit. FIG. 20 is a view showing the feature that the 58 unit is repeated for each unit included in the third unit. FIG. 21 is a view showing the feature that the 57 unit is repeated for each unit included in the third unit. FIG. 22 is a view showing the feature that the 56 unit is repeated for each unit included in the third unit. FIG. 23 is a view showing the feature that the 55 unit is repeated for each unit included in the third unit. FIG. 24 is a view showing the feature that the 54unit is repeated for each unit included in the third unit. FIG. 25 is a view showing the feature that the 53 unit is repeated for each unit included in the third unit. FIG. 26 is a view showing the feature that the 52 unit is repeated for each unit included in the third unit. FIG. 27 is a view showing the feature that the 51 unit is repeated for each unit included in the third unit.

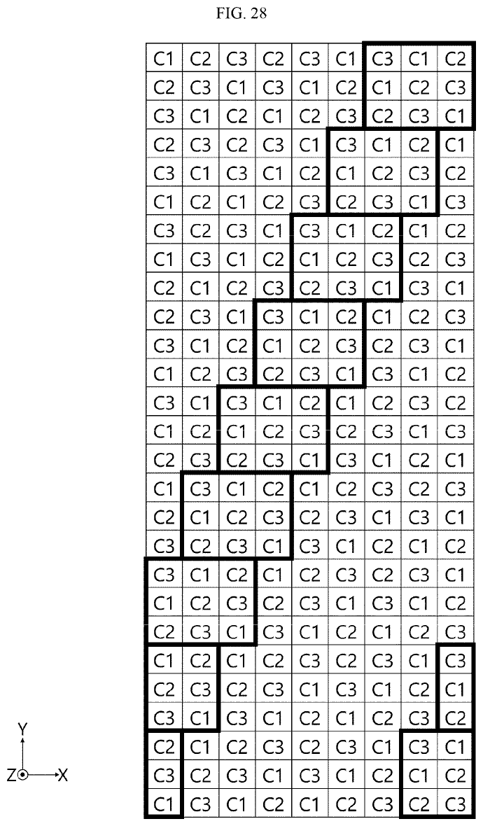

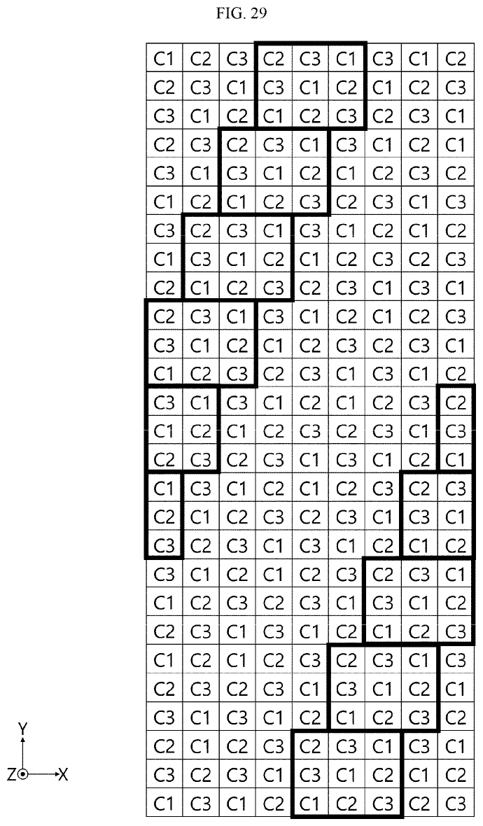

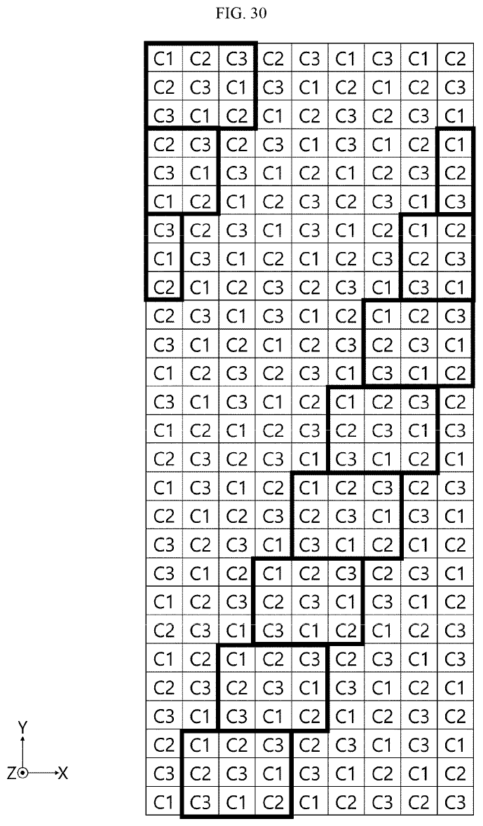

FIG. 28 is a view showing the feature that the 57 unit, the 58 unit, and the 59 unit are repeated for each unit included in the third unit. FIG. 29 is a view showing the feature that the 54 unit, the 55 unit, and the 56 unit are repeated for each unit included in the third unit. FIG. 30 is a view showing the feature that the 51 unit, the 52 unit, and the 53 unit are repeated for each unit included in the third unit.

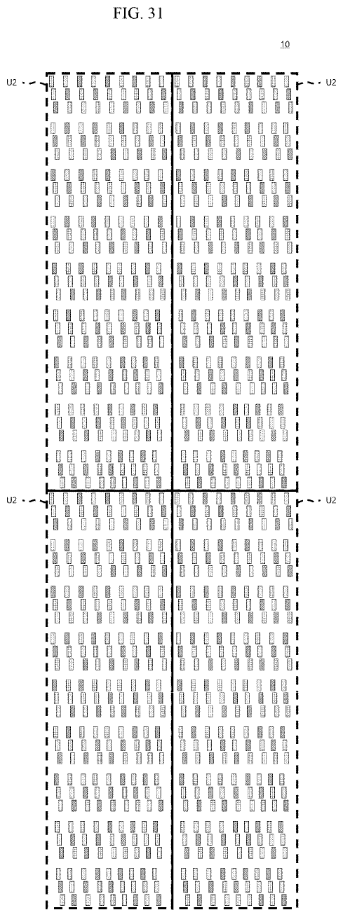

Referring to FIG. 31, in one embodiment, the display device 10 may have the sixth unit U2 repeatedly disposed in the first direction D1. The display device 10 may have the sixth unit U2 repeatedly disposed in the third direction D3.

In the color arrangement such as that of the display device 10 according to one or more embodiments of the present disclosure, the arrangement of colors viewed at the left viewing angle LVA may differ from the arrangement of colors viewed at the right viewing angle RVA. Therefore, it is possible to reduce the color moire phenomenon of the display device. The arrangement shown in FIGS. 16-31 may also achieve any of the other benefits and advantages described herein.

FIGS. 32 to 34 are schematic cross-sectional views showing a stereoscopic image display device according to one or more embodiments of the present disclosure.

Referring to FIGS. 32 to 34, a viewing angle control device 300 may comprise a base film 310, a plurality of lenses 320, a flattening layer 330, an adhesive layer 340, and a coating layer 350. An implementer may adjust the direction in which the plurality of lenses 320 are convex, the refractive index of the plurality of lenses 320, and/or the refractive index of the flattening layer 330 to improve the perception of information from the display panel 100.

The thickness 310D of the base film 310 according to one embodiment may be 30 μm to 180 μm. Alternatively, it may be from 40 μm to 170 μm. Alternatively, it may be 45 μm to 160 μm. The base film 310 according to one embodiment may comprise at least one selected from the group including Polyethylene terephthalate (PET), Polycarbonate (PC), TAC, and the like.

The thickness 320D of the plurality of lenses 320 according to one embodiment may be from 8 μm to 20 μm. Alternatively, it may be from 9 μm to 18 μm. Alternatively, it may be 10 μm to 17 μm. The refractive index of the plurality of lenses 320 according to one embodiment may be 1.5 to 1.8. Alternatively, it may be 1.52 to 1.78. Alternatively, it may be 1.54 to 1.76. Alternatively, it may be 1.56 to 1.74. The refractive index of the plurality of lenses 320 may be greater than the refractive index of the flattening layer 330. By adjusting the refractive index, the visibility of information by the light-emitting display panel may be improved.

The thickness 330D of the flattening layer 330 may be from 2 μm to 24 μm, according to one embodiment. Alternatively, it may be 3 μm to 22 μm. Alternatively, it may be 4 μm to 21 μm. The refractive index of the flattening layer 330 according to one embodiment may be 1.3 to 1.6. Alternatively, it may be 1.34 to 1.56. Alternatively, it may be 1.38 to 1.52.

The thickness 340D of the adhesive layer 340 according to one embodiment may be from 2 μm to 30 μm. Alternatively, it may be 3 μm to 28 μm. Alternatively, it may be 4 μm to 26 μm. The refractive index of the adhesive layer 340 according to one embodiment may be 1.3 to 1.6. Alternatively, it may be 1.34 to 1.56. Alternatively, it may be 1.38 to 1.52.

The reflectivity of the coating layer 350 according to one embodiment may be 5% or less. Alternatively, it may be 4% or less. Alternatively, it may be 3% or less. The haze rate of the coating layer 350 according to one embodiment may be 5% or less. Alternatively, it may be 4% or less. Alternatively, it may be 3% or less. Accordingly, light scattering is reduced and the user of the display panel can perceive accurate information on the display panel. The present disclosure also contemplates outside of the above ranges in some embodiments. Thus, the disclosure is not limited to the above preferred dimensions and values.

Referring to FIG. 32, the viewing angle control device 300 of a display device 12 may include an adhesive layer 340, a flattening layer 330 disposed on the adhesive layer 340, a plurality of lenses 320 disposed on the flattening layer 330, a base film 310 disposed on the plurality of lenses 320, and a coating layer 350 disposed on the base film 310 in sequential order from bottom to top in the Z direction. In an embodiment, the convex areas of the lenses 320 may face downward toward the display panel 100.

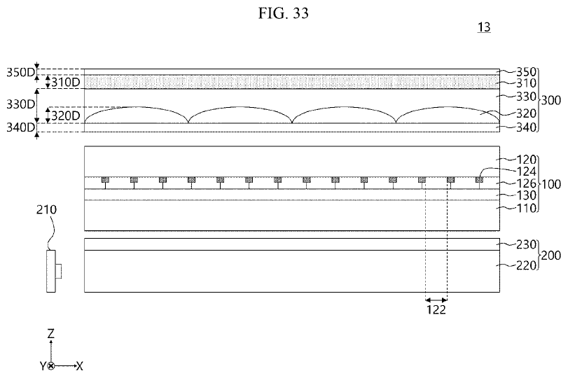

Referring to FIG. 33, the viewing angle control device 300 of a display device 13 may include an adhesive layer 340, a plurality of lenses 320 disposed on the adhesive layer 340, a flattening layer 330 disposed on the plurality of lenses 320, a base film 310 disposed on the flattening layer 330, and a coating layer 350 disposed on the base film 310 in sequential order from bottom to top in the Z direction. In other words, the order of the layers of the viewing angle control device in FIG. 33 is different than the order of the layers in FIG. 32, which may provide certain benefits or may adapt the display 12 for additional applications.

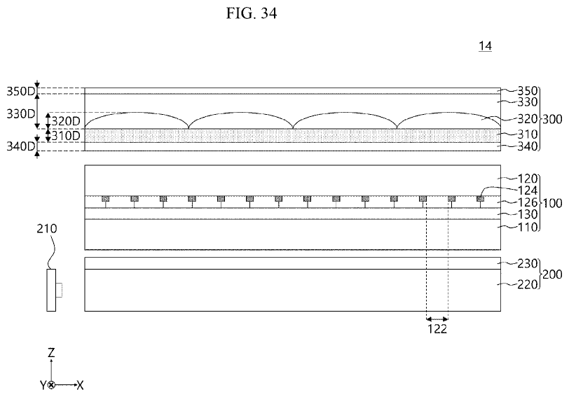

Referring to FIG. 34, the viewing angle control device 300 of a display device 14 may include an adhesive layer 340, a base film 310 disposed on the adhesive layer 340, a plurality of lenses 320 disposed on the base film 310, a flattening layer 330 disposed on the plurality of lenses 320, and a coating layer 350 disposed on the flattening layer 330 in sequential order from bottom to top in the Z direction. In both FIG. 33 and FIG. 34, the convex portions or areas of the lenses 320 faces upward and away from the display panel 100.

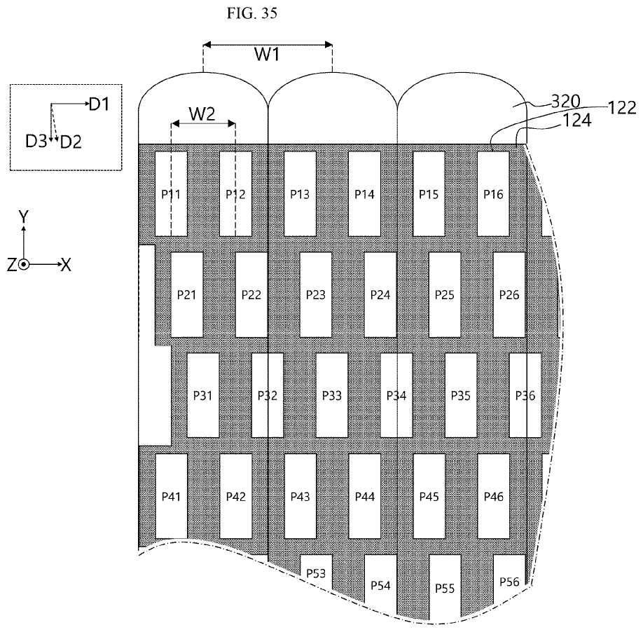

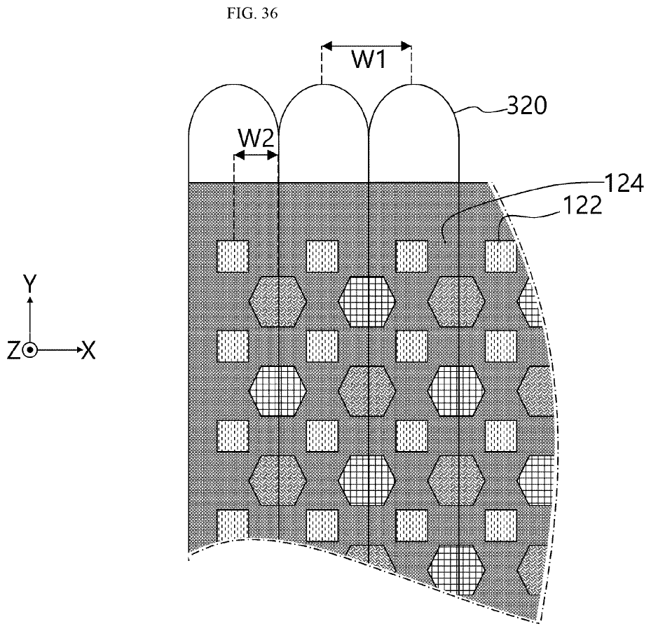

FIGS. 35 to 36 are views showing pixels and lenses disposed in the stereoscopic image display device according to one or more embodiments of the present disclosure.

Referring to FIGS. 35 to 36, the widthwise length (W2) of the pixels according to one embodiment may be from 20 μm to 40 μm. In an embodiment, the width W2 of the pixels may be measured between vertical centerlines of adjacent pixels. Alternatively, it may be 22 μm to 38 μm. Alternatively, it may be 24 μm to 36 μm. The pitch width W1 of the plurality of lenses 320 may be determined by considering the length W2 in the width direction (e.g., D1 direction) of the pixels P11, P12, etc. In an embodiment, the pitch width W1 is likewise measured between vertical centerlines of adjacent lenses 320. For example, if the pitch width W1 of the plurality of lenses 320 is formed relatively long, the thickness of the display panel may be formed relatively large to form an appropriate distance that can be used by a user. In addition, if the pitch width W1 of the plurality of lenses 320 is formed relatively short, the number of pixels P11, . . . that overlap with any one of the plurality of lenses 320 may be relatively small, which may cause efficiency problems.

In one embodiment, the pitch width W1 of the plurality of lenses 320 may be 80 μm to 100 μm. Alternatively, it may be 82 μm to 98 μm. Alternatively, it may be 84 μm to 96 μm. Alternatively, it may be 86 μm to 94 μm.

In one embodiment, the pitch width W1 may be formed as 1.5 times to 3.5 times the widthwise length W2 of the pixels. Alternatively, it may be formed from 1.6 times to 3.4 times. Alternatively, it may be formed from 1.8 times to 3.2 times. Preferably, the pitch width W1 may be 2 times to 3 times the widthwise length W2 of the pixels. The thickness of the display panel may be reduced while the efficiency of concentrating the light emitted in the above range is improved.

According to a stereoscopic image display device according to one embodiment of the present disclosure, it is possible to prevent the distortion of vertical images even when the user's eyes move vertically.

According to the stereoscopic image display device according to one embodiment of the present disclosure, it is possible to improve the visibility of the display device.

Although embodiments of the present disclosure have been described in more detail with reference to the accompanying drawings, the present disclosure is not necessarily limited to these embodiments, and various modifications may be carried out without departing from the technical spirit of the present disclosure.

Therefore, the embodiments disclosed in the present disclosure are not intended to limit the technical spirit of the present disclosure, but intended to describe the same, and the scope of the technical spirit of the present disclosure is not limited by these embodiments.

Therefore, it should be understood that the above-described embodiments are illustrative and not restrictive in all respects.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A stereoscopic image display device comprising:
a display panel; and
a plurality of lenses disposed on the display panel,
wherein the display panel includes a plurality of sub-unit pixel groups, each of the plurality of sub-unit pixel groups including a first pixel, a second pixel, and a third pixel,
wherein the plurality of sub-unit pixel groups are disposed in a first direction and a second direction intersecting the first direction,
wherein the first, second, and third pixels in each of the plurality of sub-unit pixel groups disposed in the second direction are configured to emit light of different colors, and
wherein the plurality of lenses extend in a third direction intersecting the first direction and the second direction.

2. The stereoscopic image display device of claim 1, wherein the second direction is at an angle between 0 degrees and 90 degrees with respect to the third direction.

3. The stereoscopic image display device of claim 1, wherein the first pixel is configured to emit a first color, the second pixel is configured to emit a second color, and the third pixel is configured to emit a third color,
wherein the plurality of sub-unit pixel groups form a unit having an M×N array in which N pixels are disposed in the first direction and M pixels are disposed in the second direction,
wherein the unit includes a first unit having a 1×3 array in which the first pixel, the second pixel, and the third pixel are disposed in the first direction, and the unit includes a second unit having a 3×3 array in which the first unit is disposed in the second direction, and
wherein the colors configured to emitted by the first, second, and third pixels of the second unit in the second direction are different.

4. The stereoscopic image display device of claim 3, wherein the first unit includes:
a 11 unit in which the first pixel, the second pixel, and the third pixel are sequentially disposed in the first direction;
a 12 unit in which the third pixel, the first pixel, and the second pixel are sequentially disposed in the first direction; and
a 13 unit in which the second pixel, the third pixel, and the first pixel are sequentially disposed in the first direction.

5. The stereoscopic image display device of claim 4, wherein the second unit has a 3×3 array in which the 11 unit, the 12 unit, and the 13 unit are disposed in the second direction.

6. The stereoscopic image display device of claim 5, wherein the second unit includes:
a 21 unit in which the 11 unit, the 12 unit, and the 13 unit are sequentially disposed in the second direction;
a 22 unit in which the 13 unit, the 11 unit, and the 12 unit are sequentially disposed in the second direction; and
a 23 unit in which the 12 unit, the 13 unit, and the 11 unit are sequentially disposed in the second direction.

7. The stereoscopic image display device of claim 6, wherein the unit includes a third unit having a 3×9 array in which the 21 unit, the 22 unit, and the 23 unit are disposed in the first direction.

8. The stereoscopic image display device of claim 7, wherein the third unit includes:
a 31 unit in which the 21 unit, the 22 unit, and the 23 unit are sequentially disposed in the first direction;
a 32 unit in which the 23 unit, the 21 unit, and the 22 unit are sequentially disposed in the first direction; and
a 33 unit in which the 22 unit, the 23 unit, and the 21 unit are sequentially disposed in the first direction.

9. The stereoscopic image display device of claim 8, wherein the unit includes a fourth unit in which the 31 unit, the 32 unit, and the 33 unit are disposed in the third direction intersecting the first direction and the second direction.

10. The stereoscopic image display device of claim 9, wherein, in the fourth unit, the 31 unit, the 32 unit, and the 33 unit are sequentially disposed in the third direction.

11. The stereoscopic image display device of claim 10, wherein the fourth unit is disposed in the first direction.

12. A stereoscopic image display device comprising:
a display panel having a first pixel, a second pixel, and a third pixel that implement a first color, a second color, and a third color, respectively,
wherein the first, second, and third pixels form a unit having an M×N array in which N pixels are disposed in a first direction of the display panel and M pixels are disposed in a second direction of the display panel intersecting the first direction,
wherein the unit includes a first unit having a 1×3 array and a second unit having a 3×3 array, wherein in the 3×3 array, the first unit is disposed in the second direction,
wherein the second unit includes a fifth unit having a 3×1 array, and
wherein colors configured to be emitted by the first, second, and third pixels disposed in fifth unit in the second direction are different.

13. The stereoscopic image display device of claim 12, further comprising:
a lens disposed on the display panel and extend in a third direction intersecting the first direction and the second direction.

14. The stereoscopic image display device of claim 13, wherein the lens is disposed in a light emitting direction of the first, second, and third pixels.

15. The stereoscopic image display device of claim 12, wherein the first unit includes:
a 14 unit in which the first pixel, the second pixel, and the third pixel are sequentially disposed in the first direction;
a 15 unit in which the second pixel, the third pixel, and the first pixel are sequentially disposed in the first direction; and
a 16 unit in which the third pixel, the first pixel, and the second pixel are sequentially disposed in the first direction, and
the second unit has a 3×3 array in which the 14 unit, the 15 unit, and the 16 unit are disposed in the second direction.
